(19) United States
(12) Patent Application Publication
(10) Pub. No.: US 2008/0047612 A1
(43) Pub. Date: Feb. 28, 2008

(54) AUTOMATIC DRAINING DOUBLE CHECK VACUUM BREAKER

(75) Inventor: William T. BALL, Colorado Springs, CO (US)

Correspondence Address: ZARLEY LAW FIRM P.L.C., CAPITAL SQUARE, 400 LOCUST, SUITE 200, DES MOINES, IA, 50309-2350, US

(73) Assignee: WCM INDUSTRIES, INC., Colorado Springs, CO (US)

(21) Appl. No.: 11/466,130

(22) Filed: Aug. 22, 2006

(51) Int. Cl. F16K 24/00

(52) U.S. Cl. 137/218

(57) ABSTRACT

A vacuum breaker having a housing with an inlet for connection with the wall hydrant, an outlet for connection with the hose, and a central cavity. A drain valve is disposed within the housing between the central cavity and the inlet to permit drainage of fluid from the hydrant to the outlet end of the housing when the hose is not connected thereto. A first check valve is disposed within the housing between the central cavity and the inlet to control flow between the inlet and central cavity. A second check valve is disposed within the housing between the central cavity and the outlet to control flow between the central cavity and the outlet, and the first and second check valves have an arcuate sealing surface.

### BACKGROUND OF THE INVENTION

The present invention relates to wall hydrants and, more specifically, an improved automatic draining double check backflow preventer or vacuum breaker for wall hydrants, faucets, and the like.

Backflow preventers or vacuum breakers are well known in the art. Vacuum breakers typically are placed between a wall hydrant and a hose, or similar devices, to protect the wall hydrant from back pressure. Specifically, vacuum breakers typically use a check valve to prevent pressure within the hose from backing up into the wall hydrant.

Additionally, vacuum breakers typically allow for the draining of residual water within the hydrant. This is important in colder climates, as trapped water may freeze within the hydrant and cause damage.

One such example of a vacuum breaker is disclosed in U.S. Pat. No. 5,228,470 to Lair et al. Lair et al. teaches a backflow preventer having check valves on both the inlet and outlet ends. While the Lair et al. device permits automatic draining of residual water from the inlet end, the Lair et al. device fails to adequately prevent against back pressure. Specifically, the check valves taught by Lair et al. fail under heightened back pressure, thereby causing damage to the hydrant. Accordingly, there is a need in the art for an improved vacuum breaker.

It is therefore a principal object of this invention to provide improved double check valves with a vacuum breaker device, thereby permitting both the automatic relief of back pressure and draining of residual fluid from the wall hydrant.

A further object of this invention is to provide a vacuum breaker that can prevent against greater back pressure.

Still a further object of this invention is to provide a vacuum breaker that minimizes the number of moving parts, thereby minimizing cost.

These and other objects will be apparent to those skilled in the art.

### BRIEF SUMMARY OF THE INVENTION

The present invention is directed toward a vacuum breaker for installation between a wall hydrant and a detachable hose. A housing is provided having an inlet for connection with the wall hydrant, an outlet for connection with the hose, and a central cavity. A drain valve is provided within the housing between the central cavity and the inlet to permit drainage of fluid from the hydrant to the outlet end of the housing when the hose is not connected thereto. A first check valve is provided within the housing between the central cavity and the inlet to control flow between the inlet and central cavity. A second check valve is provided within the housing between the central cavity and the outlet to control flow between the central cavity and the outlet, and the first and second check valves have an arcuate shaped sealing surface.

### BRIEF DESCRIPTION OF THE DRAWINGS

FIG. 1 is a sectional view of an embodiment of the present invention as shown without a hose attachment and disconnected from an inlet supply;

FIG. 2 is the invention of FIG. 1 as shown connected to an inlet supply pressure without a hose attachment;

FIG. 3 is the invention of FIG. 1 as shown connected to an inlet supply pressure with a hose attachment;

FIG. 4 is the invention of FIG. 3 as shown when flow from the inlet supply has stopped;

FIG. 5 is the invention of FIG. 4 as shown with back pressure from the hose attachment;

FIG. 6 is the invention of FIG. 1 as shown connected to an inlet supply with residual pressure without a hose attachment;

FIG. 7 is a sectional view of another embodiment of the present invention as shown without a hose attachment and disconnected from an inlet supply; and

FIG. 8 is a sectional view of another embodiment of the present invention as shown without a hose attachment and disconnected from an inlet supply.

### DESCRIPTION OF THE PREFERRED EMBODIMENTS OF THE INVENTION

With reference to the drawings, an automatic draining double check backflow preventer or vacuum breaker 10 is shown having a two-piece housing 12, including an adapter 14 and a body 16. The adapter 14 has a threaded inlet 18 for connection with a conventional faucet or wall hydrant 20. The body 16 has a threaded outlet 22 for connection with a conventional garden hose 24. The adapter 14 and body 16 are threadably connected. Alternatively, the adapter 14 and body 16 are connected by solder, adhesive, or any other conventional means. Housing 12 also may be of single-piece construction such that adapter 14 and body 16 are integrally constructed. A central bore 26 extends through the housing 12 to fluidly connect the inlet 18 and outlet 22.

Drain ports 28 are disposed in a shoulder portion 30 of body 16 and are connected to axial passageways 32, which are in fluid connection with the central bore 26. The drain ports 28 serve to drain residual fluid or relieve backpressure within the hose 24, as described hereafter.

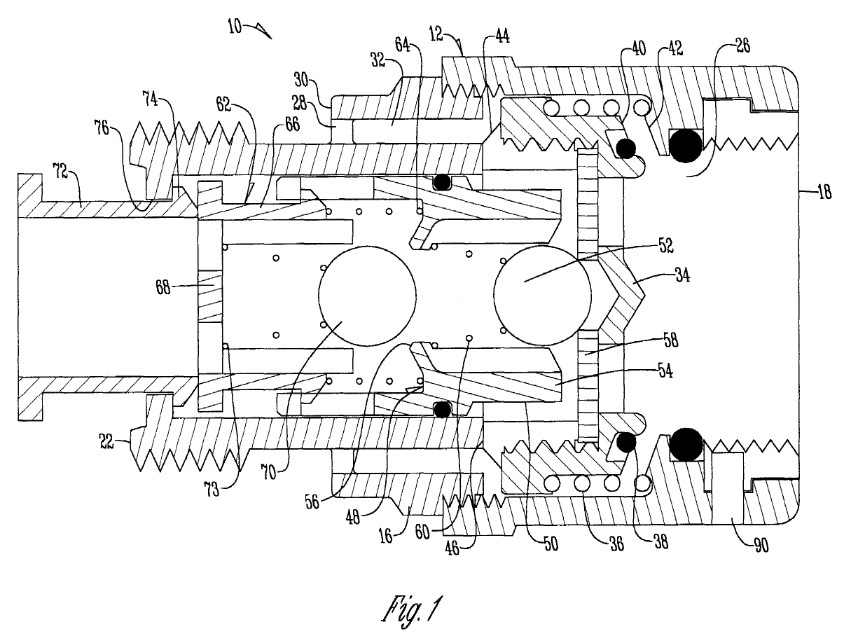

A bonnet 34 is slidably received within the central bore 26 of housing 12 and is positioned within the adapter 14. A spring 36 biases the bonnet 34 in an open position, as shown in FIG. 1, such that axial passageways 32 are in fluid connection with the inlet 18. An O-ring 38 is retained by a shoulder portion 40 of the bonnet 34. Bonnet 34 shifts to a closed position, as described hereafter, such that O-ring 38 engages with a seat portion 42 of the central bore 26, thereby sealing the axial passageways 32 from the inlet 18. In this manner, the bonnet 34 serves as a drain valve to permit drainage of fluid from the inlet 18 to the drain ports 28.

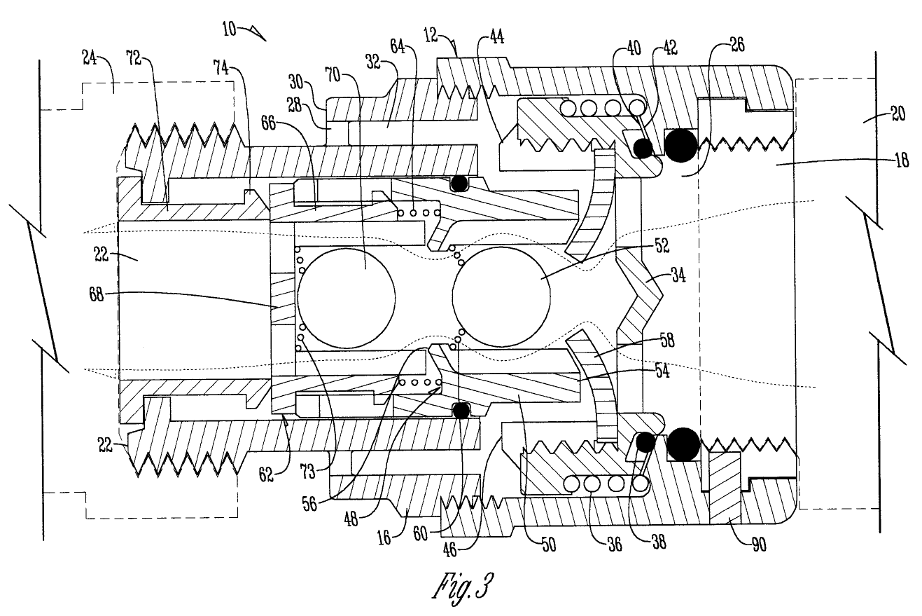

Opposite the shoulder portion 40 of the bonnet 34 is a second shoulder portion 44 that engages with end 46 of body 16. When the bonnet 34 shifts to the closed position, as shown in FIG. 3, back pressure from the outlet 22 is relieved via drain port 28.

A body seat 48 is mounted within the central bore 26 of housing 12 and is positioned at end 46 of body 16. Body seat 48 includes side walls 50 that retain a first check valve 52. Side walls 50 terminate in a seat ring 54 on one end and a seat portion 56 on the opposite end.

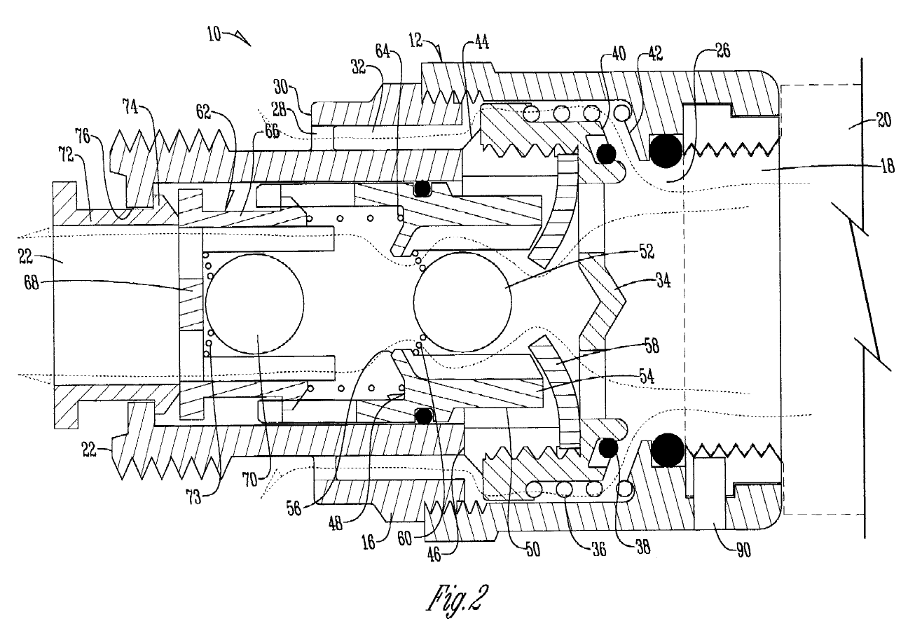

A flexible, annular-shaped seat disc 58 is retained by shoulder portions 40 and 44. When no pressure is exerted at the inlet 18, check valve 52, which is biased to a closed position by a spring 60, engages with the seat disc 58, as shown in FIG. 1. As described hereafter, check valve 52 shifts to an open position, as shown in FIG. 2, when pressure exerted at the inlet 18 overcomes the force of spring 60. Pressure at the inlet 18 causes the seat disc 58 to bend inwardly, as shown in FIG. 2, and deflect about the seat ring 54 of body seat 48.

A spool 62 is slidably received within the central bore 26 of housing 12 and is positioned within body 16 adjacent the body seat 48. Spool 62 is biased to a first position, as shown in FIG. 1, by spring 64. Spool 62 includes side walls 66 and an end 68 that retain a second check valve 70, which is supported by a spring 73.

A piston 72 is slidably received within the central bore 26 and is positioned within the body 16 at outlet 22 adjacent spool 62. Piston 72 has a flange 74 that engages with a detent 76 at outlet 22 to retain piston 72 within body 16. When garden hose 24 is connected to outlet 22, piston 72 is driven inwardly, thereby compressing spring 64 and shifting spool 62 to a second position, as shown in FIG. 3.

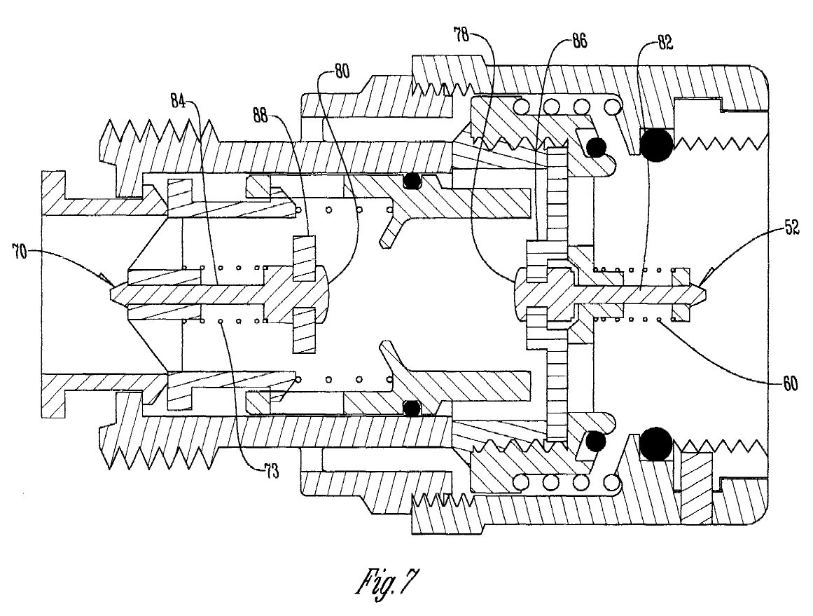

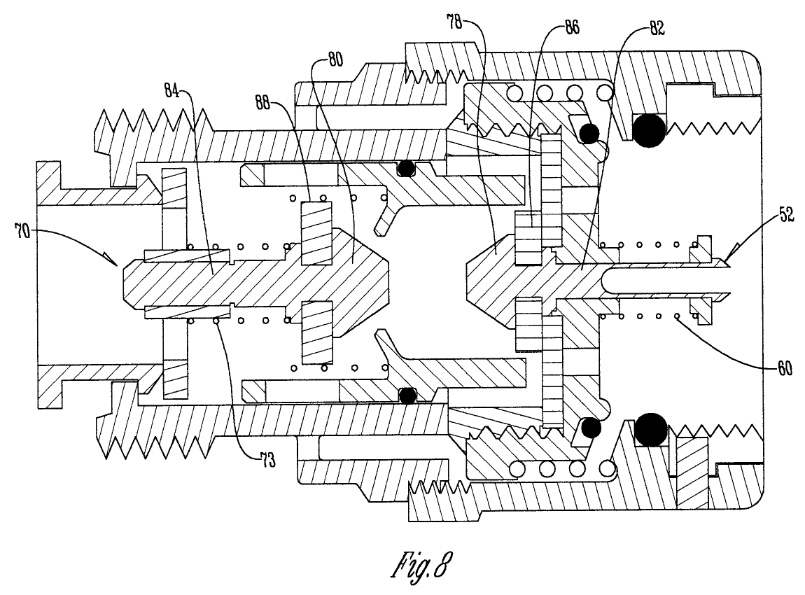

Check valves 52 and 70 preferably are spherical members, as shown in FIGS. 1-6, that are biased to closed positions against seats 58 and 56 by springs 60 and 73. As such, check valves 52 and 70 have an arcuate sealing surface. Alternatively, check valves 52 and 70 are pusher posts, as shown in FIGS. 7 and 8. Specifically, check valves 52 and 70 include head members 78 and 80 having an arcuate sealing surface and attached to posts 82 and 84. Head members 78 and 80 also include annular-shaped seals 86 and 88. Check valves 52 and 70 are of sufficient strength to prevent against heightened back pressure, including ASSE 1052 standards.

In operation, the inlet 18 of the vacuum breaker 10 is connected to the hydrant 20. Screw 90 is tightened to secure the vacuum breaker 10 to the hydrant 20 and prevent removal. Garden hose 24 is threadably attached to the outlet 22, and the hydrant 20 is adjusted to vary the pressure of fluid passing through the vacuum breaker 10, as described hereafter.

When no pressure is exerted at the inlet 18 and hose 24 is not connected to outlet 22, the vacuum breaker 10 is in a position of rest, as shown in FIGS. 1, 7, and 8. Specifically, bonnet 34 is in the open position such that the axial passageways 32 are in fluid communication with the inlet 18. Additionally, check valves 52 and 70 are in closed positions.

As fluid pressure is exerted at the inlet 18, check valve 52 shifts to the open position, as shown in FIG. 2. In this manner, fluid from the inlet 18 is allowed to flow through the central bore 26, past both check valves 52 and 70, and through outlet 22. Additionally, fluid is allowed to pass through axial passageways 32 and exit through drain ports 28.

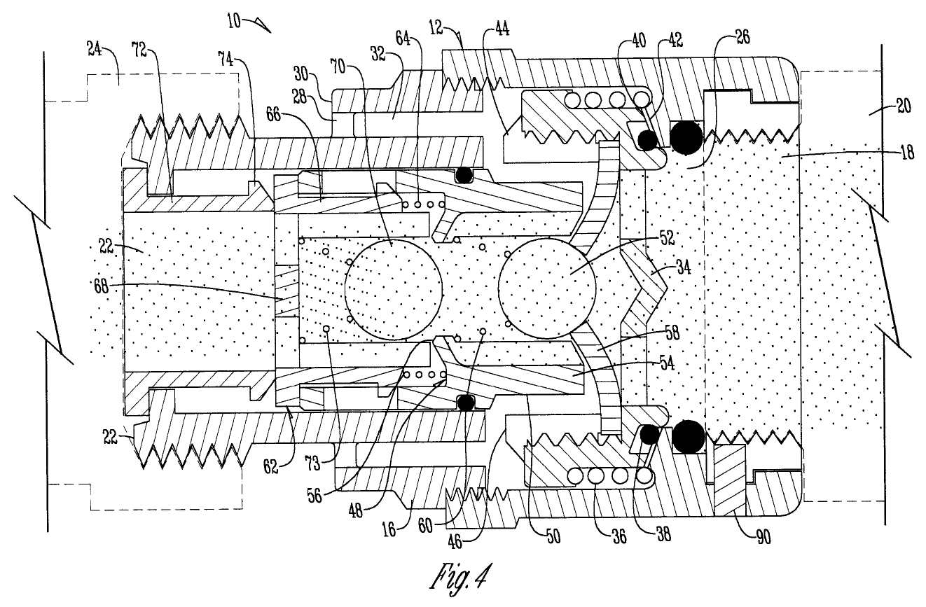

When hose 24 is connected to the outlet 22, piston 72 and spool 62 shift inwardly, as shown in FIG. 3. In this arrangement, the bonnet 34 is shifted to the closed position such that axial passageways 32 are sealed from fluid communication with central bore 26 by O-ring 38. Check valve 52 returns to the closed position, as shown in FIG. 4, when fluid pressure at the inlet 18 diminishes to a magnitude less than the force of spring 60.

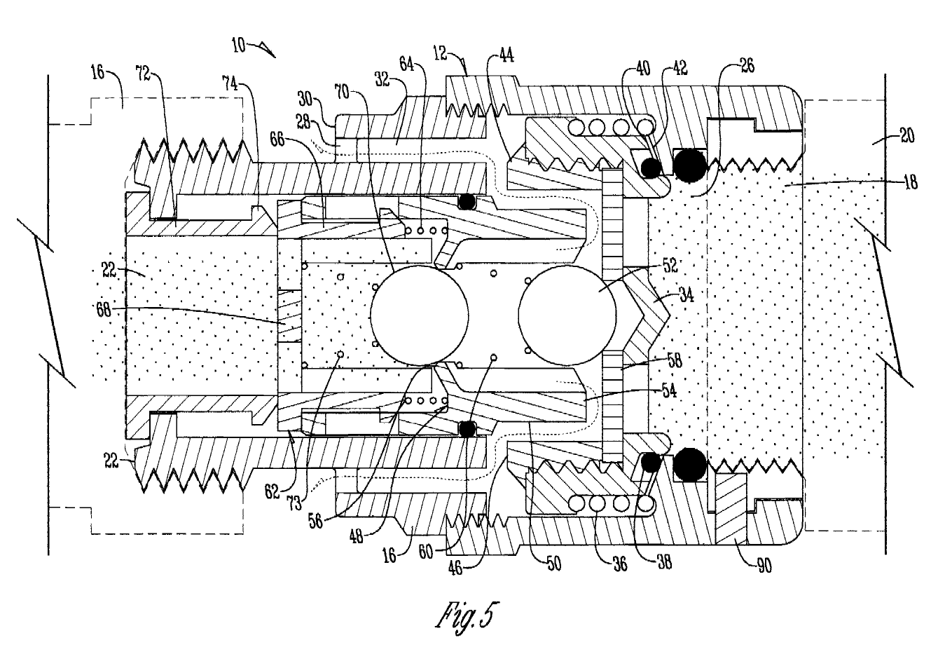

Vacuum breaker 10 also serves to relieve back pressure at outlet 22 from hose 24. Specifically, and with reference to FIG. 5, back pressure at the outlet 22 forces seat disc 58 to the upright position such that seat disc 58 is not engaged with seat ring 54. In this manner, axial passageways 32 are in fluid communication with central bore 26, thereby allowing back pressure to vent through drain ports 28.

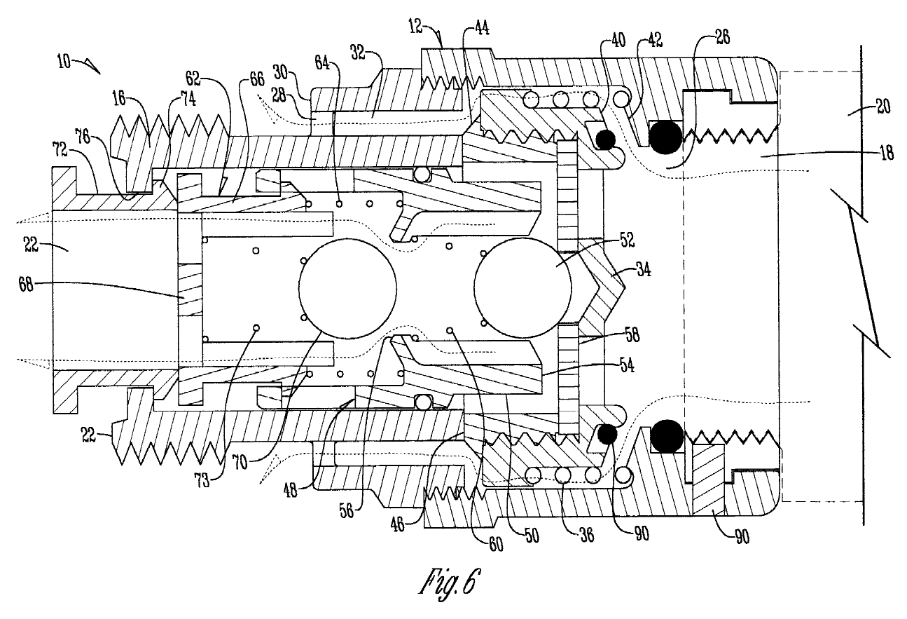

Vacuum breaker 10 also is automatically draining to relieve residual fluid from the inlet 18. Specifically, and with reference to FIG. 6, residual fluid at the inlet 18 is allowed to drain through drain ports 28 when the hose 24 is disconnected from the outlet 22.

It is therefore seen that through the use of improved double check valves, this invention permits both the automatic relief of back pressure and draining of residual fluid from a wall hydrant.

What is claimed is:

1. A vacuum breaker for installation between a wall hydrant and a detachable hose comprising:
a housing having an inlet for connection with the wall hydrant and an outlet for connection with the hose;
a central cavity within the housing;
a drain valve located within the housing between the central cavity and the inlet to permit drainage of fluid from the hydrant to the outlet end of the housing when the hose is not connected thereto;
a first check valve located within the housing between the central cavity and the inlet to control flow between the inlet and central cavity;
a second check valve located within the housing between the central cavity and the outlet to control flow between the central cavity and the outlet; and
the first and second check valves having an arcuate sealing surface.

2. The device of claim 1 wherein the first and second check valves are connected to posts.

3. The device of claim 2 wherein the first and second check valves have annular seals.
